(19) United States
(12) Patent Application Publication
(10) Pub. No.: US 2016/0308276 A1
(43) Pub. Date: Oct. 20, 2016

(54) SYSTEM AND METHOD FOR DYNAMIC SWITCHING OF ANTENNAS

(71) Applicant: Dell Products L.P., Round Rock, TX (US)

(72) Inventors: Ching-Wei Chang, New Tapei City (TW); I-Yu Chen, Taipei (TW); Yung-Chang Wei, Taipei (TW)

(21) Appl. No.: 14/686,482

(22) Filed: Apr. 14, 2015

(51) Int. Cl. H01Q 3/24

(52) U.S. Cl. CPC H01Q 3/24

(57) ABSTRACT

Systems and methods are disclosed for dynamic switching of antennas. A portable information handling system includes a housing having a plurality of edges, a first antenna and a second antenna. The first antenna is located proximate a first edge of the plurality of edges, the second antenna is located proximate a second edge of the plurality of edges. The system includes a switch communicatively coupled to the first antenna and the second antenna, and a processing resource communicatively coupled to the switch. The processing resource is configured to determine a first orientation of the portable information handling system; based on the first orientation, designate the first antenna as a primary antenna and designate the second antenna as a secondary antenna; and direct the switch to transition the primary antenna to an active state and direct the switch to transition the secondary antenna to an inactive state.

### TECHNICAL FIELD

This disclosure relates generally to information handling systems and, more particularly, to a system and method for dynamic switching of antennas.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Examples of information handling systems include portable information handling systems, such as, smart phones, tablet computers, notebook computers, media players, digital cameras, 2-in-1 tablet-laptop combination computers, and wireless organizers. These devices may communicate across wireless networks using voice, images, text, video, and data. A portable information handling system may generally be any device that a user may carry for handheld use and that includes a processor, and may be proximate to or in contact with a user while being utilized. Energy emitted from the portable information handling system may be absorbed by the user and a measurement of such energy absorbed may be expressed as the Specific Absorption Rate (SAR). SAR requirements may define the amount of energy a user can safely absorb. To meet SAR requirements, energy emitted from the portable information handling system may be inhibited by reducing or eliminating power supplied to an antenna. Reducing or eliminating power to an antenna may result in connection issues, low data rates, and in some cases, disconnection from the wireless networks. Thus, the management of power reduction in portable information handling system may be necessary.

### SUMMARY

In some embodiments, a portable information handling system is disclosed that includes a housing having a plurality of edges. The system also includes a first antenna and a second antenna. The first antenna is located proximate a first edge of the plurality of edges, the second antenna is located proximate a second edge of the plurality of edges. The system further includes a switch communicatively coupled to the first antenna and the second antenna, and a processing resource communicatively coupled to the switch. The processing resource is configured to determine a first orientation of the portable information handling system, and based on the first orientation, designate the first antenna as a primary antenna and designate the second antenna as a secondary antenna. The processing resource is also configured to direct the switch to transition the primary antenna to an active state and direct the switch to transition the secondary antenna to an inactive state.

In another embodiment, a method is disclosed that includes determining, by a processing resource, a first orientation of a portable information handling system, the portable information handling system comprising a housing having a plurality of edges. The method also includes, based on the first orientation, designating a first antenna as a primary antenna and designate a second antenna as a secondary antenna. The first antenna is located proximate a first edge of the plurality of edges, and the second antenna is located proximate a second edge of the plurality of edges. The method further includes directing, by the processing resource, a switch to transition the primary antenna to an active state and directing the switch to transition the secondary antenna to an inactive state. The switch is communicatively coupled to the first antenna and the second antenna.

In a further embodiment, a non-transitory computer-readable medium is disclosed that stores instructions that, when executed by a processor, cause the processor to determine a first orientation of a portable information handling system, the portable information handling system comprising a housing having a plurality of edges. The processor is also caused to, based on the first orientation, designate a first antenna as a primary antenna and designate a second antenna as a secondary antenna. The first antenna is located proximate a first edge of the plurality of edges, and the second antenna is located proximate a second edge of the plurality of edges. The processor is further caused to direct a switch to transition the primary antenna to an active state and direct the switch to transition the secondary antenna to an inactive state. The switch is communicatively coupled to the first antenna and the second antenna.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of selected elements of an embodiment of a portable information handling system in accordance with some embodiments of the present disclosure;

FIG. 2 illustrates block diagrams of selected elements of portable information handling systems in varied orientations in accordance with some embodiments of the present disclosure; and

FIG. 3 illustrates a flowchart depicting selected elements of an embodiment of a method for dynamic switching of antennas in accordance with some embodiments of the present disclosure.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

As noted previously, many information handling systems or groups of information handling systems may be configured as portable information handling systems that utilize wireless networks to transmit and receive data. To transmit and receive the data, portable information handling systems may use one or multiple antennas. Utilizing multiple antennas may increase bandwidth, and device coverage and improve communications. Such configurations may be described as Multiple Input Multiple Output (MIMO) systems. However, multiple antennas may increase power consumption and energy that may be absorbed by a user. Energy absorption requirements, also referred to as the Specific Absorption Rate (SAR), are regulated by the Federal Communications Commission (FCC) and European Conformity (CE). To meet FCC/CE requirements some portable information handling systems incorporate a sensor that detects when a user is in close proximity to the system, also referred to as a “p-sensor.” When the p-sensor detects a user, power reduction measures may occur including removing or reducing power from some or all of the antennas. This power reduction may result in connection problems, low data rates, and in some instances, disconnection from the wireless network.

In some embodiments of the present disclosure, the use of a switching system with multiple antennas may result in minimal or no connectivity reduction during normal operation while maintaining SAR requirements. Further, embodiments of the present disclosure may be implemented without use of a p-sensor and maintain compliance with SAR requirements. In some embodiments, an accelerometer may be combined with a switching system to trigger primary antennas into an active state and secondary antennas into an inactive state based on the configuration of the portable information handling system. An antenna in an active state may indicate that the antenna is transmitting information, such as, voice, images, text, video, and data. An antenna in an inactive state may indicate that the antenna is receiving data, supporting other bands or technologies, or otherwise emitting substantially no or negligible energy. Primary antennas may include one or more antennas, for example, primary antennas may be a pair or antennas on the uppermost edge of a housing for a portable information handling system. Maintaining primary antennas on the uppermost edge of the portable information handling system may assist in ensuring that the active antennas are less prone to be proximate to a user or a user's hands. Thus, embodiments of the present disclosure may ensure that antennas are maintaining connectivity and enabling maximum performance of the portable information handling system while sustaining SAR requirements and minimizing power usage.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, a server, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Additionally, the information handling system may include firmware for controlling and/or communicating with, for example, hard drives, network circuitry, memory devices, I/O devices, and other peripheral devices. For example, a bus switch and a root port may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

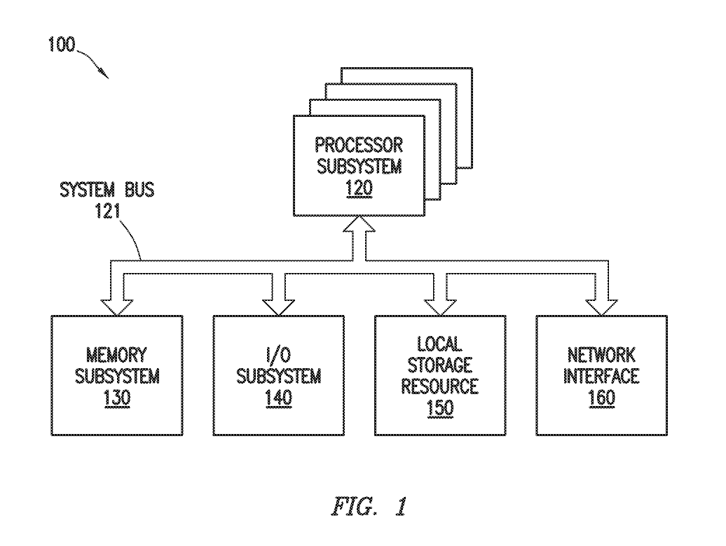

Particular embodiments are best understood by reference to FIGS. 1, 2, and 3 wherein like numbers are used to indicate like and corresponding parts.

FIG. 1 illustrates a block diagram of selected elements of an embodiment of portable information handling system 100 in accordance with some embodiments of the present disclosure. In various embodiments, portable information handling system 100 may represent different types of portable information handling systems, such as, smart phones, tablet computers, notebook computers, media players, digital cameras, 2-in-1 tablet-laptop combination computers, and wireless organizers. In various embodiments, portable information handling system 100 may be operated by the user using a keyboard and a mouse (not shown). Components of portable information handling system 100 may include, but are not limited to, processor subsystem 120, which may comprise one or more processors, and system bus 121 that communicatively couples various system components to processor subsystem 120 including, for example, memory subsystem 130, I/O subsystem 140, local storage resource 150, and network interface 160.

Processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130). In the same or alternative embodiments, processor subsystem 120 may interpret and/or execute program instructions and/or process data stored remotely (e.g., in a network storage resource, not shown).

System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, PCI bus, PCI-E bus, HyperTransport (HT) bus, and Video Electronics Standards Association (VESA) local bus, among others.

Memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In portable information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. For example, I/O subsystem 140 may comprise a touch panel and display adapter.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data.

Network interface 160 may be a suitable system, apparatus, or device operable to serve as an interface between portable information handling system 100 and a network (not shown). Network interface 160 may enable portable information handling system 100 to communicate over the network using a suitable transmission protocol and/or standard, including, but not limited to various transmission protocols and/or standards. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 160 and/or various components associated therewith may be implemented using hardware, software, or any combination thereof.

As noted previously, portable information handling systems, such as portable information handling system 100, may be configured to operate in multiple orientations. As will be described in further detail herein, the present disclosure illustrates switching multiple antennas between an active state and an inactive state based on the orientation of the portable information handling system to conserve power and comply with SAR requirements.

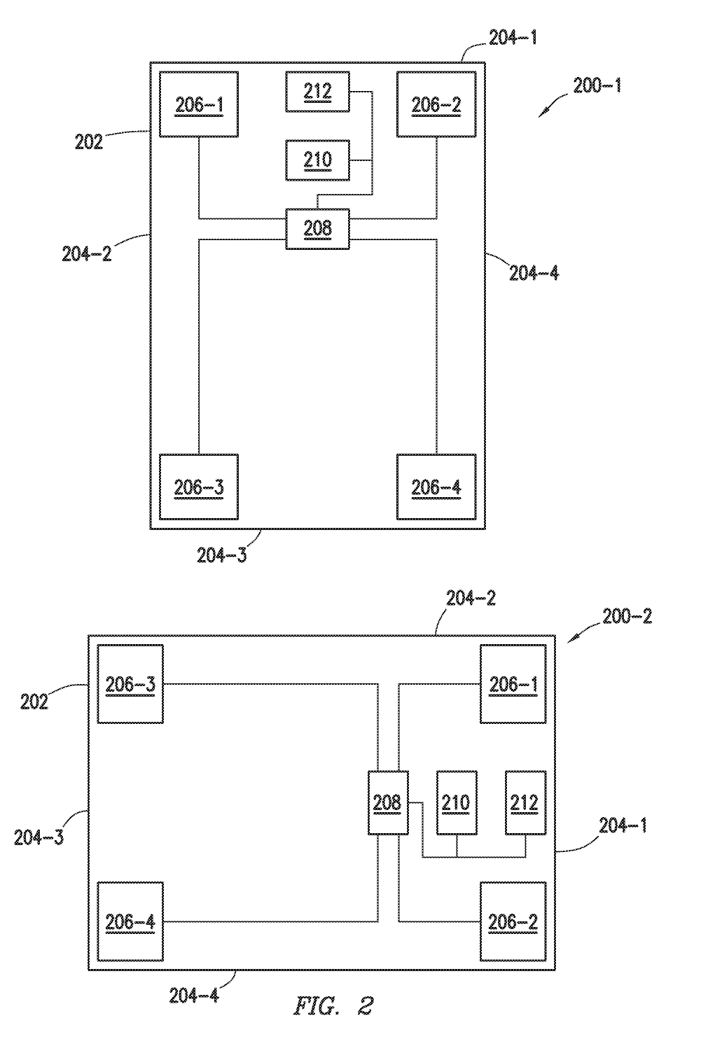

FIG. 2 illustrates block diagrams of selected elements of portable information handling system 200 in a multiple orientations in accordance with some embodiments of the present disclosure. Portable information handling systems 200-1 and 200-2 (collectively “portable information handling systems 200”) may include housing 202 that has edges 204-1, 204-2, 204-3, and 204-4 (collectively “edges 204”). Portable information handling systems 200 may also include antennas 206-1, 206-2, 206-3 and 206-4 (collectively “antennas 206”), switching system 208 communicatively coupled to each of antennas 206 and accelerometer 210, and processing resource 212 communicatively coupled to accelerometer 210 and switching system 208.

Specifically, portable information handling system 200-1 illustrates housing 202 rotated for viewing the display in a portrait orientation. For example, edges 204-2 and 204-4, which may be longer than edges 204-1 and 204-3, may be oriented approximately vertically. Additionally, portable information handling system 200-2 illustrates housing 202 rotated for viewing the display in a landscape orientation. For example, edges 204-2 and 204-4, which may be longer than edges 204-1 and 204-3, may be oriented approximately horizontally.

Based on the orientation of housing 202, different antennas 206 may be designated as primary antennas and transitioned to an active state, e.g., the uppermost antennas in each orientation may be designated as primary antennas. For example, portable information handling system 200-1 is shown with housing 202 oriented such that antennas 206-1 and 206-2 are the uppermost antennas. In this case, antennas 206-1 and 206-2 may be designated as primary antennas, and if either antennas 206-1 and 206-2 are in an inactive state, may be transitioned to an active state. Further, antennas 206-3 and 206-4 may be designated as secondary antennas, and if either antennas 206-3 and 206-4 are in an active state, may be transitioned to an inactive state. As another example, portable information handling system 200-2 is shown with housing 202 oriented such that antennas 206-1 and 206-3 are the uppermost antennas. In this case, antennas 206-1 and 206-3 may be designated as primary antennas, and if either antennas 206-1 and 206-3 are in an inactive state, may be transitioned to an active state. Antennas 206-2 and 206-4 may be designated as secondary antennas, and if either antennas 206-2 and 206-4 are in an active state, may be transitioned to an inactive state. Transitioning an antenna to an inactive state reduces energy emitted from the antenna and may allow portable information handling system 200 to comply with SAR requirements while maintaining adequate connection with a network through the use of one or more antennas that remain in an active state. Although two example orientations for portable information handling system 200 are illustrated, e.g., portable information handling system 200-1 and 200-2, it is noted that multiple orientations for portable information handling system 200 are contemplated in embodiments of the present disclosure.

In some embodiments, antennas 206 may be communicatively coupled to switching system 208 and may be configured to receive and transmit data. Antennas 206 may be configured at any location within housing 202. For example, antennas 206 may be configured proximate edges 204 or proximate corners of housing 202. Antennas 206 may be placed with a minimum distance between antennas 206. For example, antennas 206 may be placed with a minimum of approximately one centimeter between adjacent antennas 206. Antennas 206 may be configured to communicate via any suitable wireless technology. Antennas 206 may be operable to cooperatively transmit and receive data using all or any subset of antennas 206. Antennas 206 may be one of multiple types of antennas, including but not limited to, directional antennas, parabolic antennas, dipole antennas, or any other suitable type of antenna. In some embodiments, antennas 206 may include transceivers to facilitate transmission of data. Further, although four example antennas 206 are shown for portable information handling systems 200, it is noted that more or fewer antennas 206 may be included in embodiments of the present disclosure. For example, a bezel installed proximate edges 204 may be utilized that includes numerous antennas 206. As another example, portable information handling system 200 may include six, eight, or ten antennas 206.

Switching system 208 may be communicatively coupled to antennas 206, accelerometer 210, and processing resource 212. Switching system 208 may include one or more switches for transitioning antennas 206 between inactive states and active states.

Accelerometer 210 may be communicatively coupled to switching system 208 and processing resource 212. Accelerometer 210 may be configured to determine the orientation of portable information handling system 200, for example, in order to correctly display images on a display screen. Accelerometer 210 may additionally be configured to ascertain a particular spatial orientation during usage, for example, to distinguish between usages when portable information handling system 200 is resting on a working surface versus when portable information handling system 200 is handheld by a user. Further, portable information handling system 200 may include a gyroscope and/or a magnetometer to assist in spatial orientation determination.

Processing resource 212 may be communicatively coupled to accelerometer 210 and switching system 208. Processing resource 212 may comprise a system, device, or apparatus operable to interpret and/or execute program instructions and/or process data, and may include a microprocessor, microcontroller, DSP, ASIC, or another digital or analog circuitry configured to interpret and/or execute program instructions and/or process data. In some embodiments, processing resource 212 may interpret and/or execute program instructions and/or process data stored locally (e.g., in memory subsystem 130 shown with reference to FIG. 1). In some embodiments, processing resource 212 may be similar to or may be included in processor subsystem 120 discussed with reference to FIG. 1.

In operation, accelerometer 210 may communicate an orientation to switching system 208 and/or processing resource 212. Based on the orientation, processing resource 212 may designate one or more antennas 206 as primary antennas. Processing resource 212 may designate the remaining antennas 206 as secondary antennas. Processing resource 212 may direct switching system 208 to transition primary antennas to an active state and to transition secondary antennas to an inactive state.

In some embodiments, accelerometer 210 may communicate that the orientation of portable information handling system 200 is substantially flat, e.g., portable information handling system 200 is resting on a surface. In such a case, one or more antennas 206 may be designated as default primary antennas. For example, antennas 206-1 and 206-2 may be designated as default primary antennas.

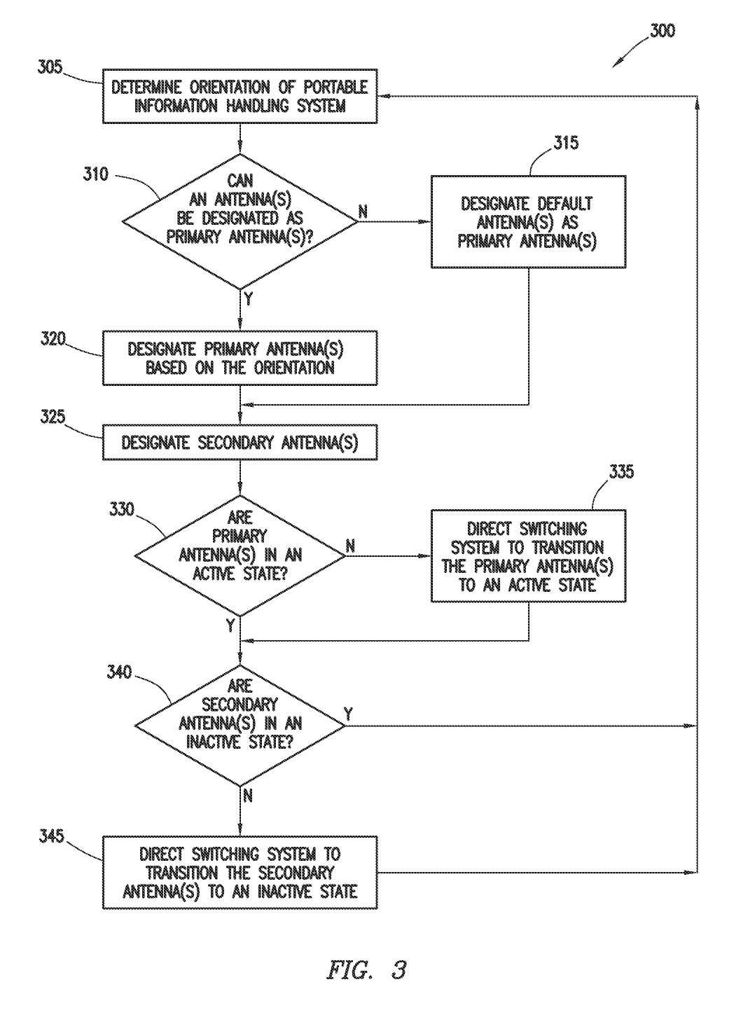

FIG. 3 illustrates a flowchart depicting selected elements of an embodiment of a method 300 for dynamic switching of antennas. The steps of method 300 may be performed by various computer programs, models or any combination thereof. The programs and models may include instructions stored on a non-transitory computer-readable medium that are operable to perform, when executed, one or more of the steps described below. The computer-readable medium may include any system, apparatus or device configured to store and/or retrieve programs or instructions such as a microprocessor, a memory, a disk controller, a compact disc, flash memory or any other suitable device. The programs and models may be configured to direct a processor or other suitable unit to retrieve and/or execute the instructions from the computer-readable medium. For example, method 300 may be executed by a processing resource of a portable information handling system and/or other suitable source. For illustrative purposes, method 300 may be described with respect to the processing resource 212 of portable information handling system 200 shown in FIG. 2; however, method 300 may be used for any processor, controller, or any other component of a portable information handling system of any suitable configuration.

In step 305, a processing resource determines an orientation of the portable information handling system. The orientation may be determined based on a signal received from an accelerometer, such as accelerometer 210 discussed with reference to FIG. 2. For example, processing resource 212 may determine that portable information handling system 200 is oriented in a portrait orientation or a landscape orientation.

In step 310, the processing resource determines if the orientation of the portable information handling system allows one or more antennas to be designated as one or more primary antennas. For example, if portable information handling system 200 is in a portrait orientation, e.g., orientation illustrated for portable information handling system 200-1, then processing resource 212 may determine that edge 204-1 is located at the top of portable information handling system 200. Antennas 206-1 and 206-2 located proximate to edge 204-1 may be designated as primary antennas. As another example, if portable information handling system 200 is in a landscape orientation, e.g., orientation illustrated for portable information handling system 200-2, then processing resource 212 may determine that edge 204-2 is located at the top of portable information handling system 200. Antennas 206-1 and 206-3 may be designated as primary antennas. If the processing resource is able to designate one or more antennas as one or more primary antennas, then method 300 proceeds to step 320. If the orientation of portable information handling system 200 does not indicate one or more primary antennas, then method 300 proceeds to step 315.

At step 315, the processing resource may designate one or more default antennas as one or more primary antennas. For example, antennas 206-1 and 206-2 may be assigned as default antennas, and processing resource 212 may designate antennas 206-1 and 206-2 as the primary antennas.

In step 320, the processing resource designates one or more primary antennas based on the orientation. For example, if portable information handling system 200 is in a portrait orientation, e.g., orientation illustrated for portable information handling system 200-1, then processing resource 212 may designate antennas 206-1 and 206-2 located proximate to edge 204-1 as primary antennas. As another example, if portable information handling system 200 is in a landscape orientation, e.g., orientation illustrated for portable information handling system 200-2, then processing resource 212 may designate antennas 206-1 and 206-3 as primary antennas.

In step 325, the processing resource designates one or more secondary antennas. Processing resource 212 may designate each antenna not designated as a primary antenna in step 320 as a secondary antenna.

In step 330, the processing resource determines if the one or more primary antennas are in an active state. For example, if antennas 206-1 and 206-2 are designated as primary antennas, processing resource 212 may determine if antennas 206-1 and 206-2 are in an active state. If the processing resource determines that one or more of the primary antennas are not in an active state, then method 300 proceeds to step 335 and the processing resource directs the switching system to transition the one or more primary antennas to an active state. If the processing resource determines that the one or more primary antennas are all in an active state, then method 300 proceeds to step 340.

In step 340, the processing resource determines if the one or more secondary antennas are in an inactive state. For example, if antennas 206-3 and 206-4 are designated as secondary antennas, processing resource 212 may determine if antennas 206-3 and 206-4 are in an inactive state. If the processing resource determines that one or more of the secondary antennas are not in an inactive state, then method 300 proceeds to step 345 and the processing resource directs the switching system to transition the secondary antenna or subset of antennas to an inactive state.

Modifications, additions, or omissions may be made to method 300 without departing from the scope of the present disclosure. For example, the order of the steps may be performed in a different manner than that described and some steps may be performed at the same time. For example, step 320 and step 325 may be performed simultaneously. Additionally, each individual step may include additional steps without departing from the scope of the present disclosure. For example, step 315 may include additional steps or options as described herein without departing from the scope of the present disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A portable information handling system, comprising:
a housing having a plurality of edges;
a first antenna and a second antenna, the first antenna located proximate a first edge of the plurality of edges, the second antenna located proximate a second edge of the plurality of edges;
a switch communicatively coupled to the first antenna and the second antenna; and
a processing resource communicatively coupled to the switch, the processing resource configured to:
determine a first orientation of the portable information handling system;
based on the first orientation, designate the first antenna as a primary antenna and designate the second antenna as a secondary antenna; and
direct the switch to transition the primary antenna to an active state and direct the switch to transition the secondary antenna to an inactive state.

2. The system of claim 1, wherein determining the first orientation of the portable information handling system includes receiving a signal from an accelerometer communicatively coupled to the switch and the processing resource.

3. The system of claim 1, wherein the first antenna and the second antenna are separated by at least a predefined distance.

4. The system of claim 1, wherein the processing resource is further configured to:
determine a second orientation of the portable information handling system; and
based on the second orientation, designate the second antenna as the primary antenna and designate the first antenna as the secondary antenna.

5. The system of claim 4, wherein the first orientation is a portrait orientation and the second orientation is a landscape orientation.

6. The system of claim 1, wherein the first antenna comprises a pair of antennas configured to cooperatively transmit and receive information.

7. The system of claim 1, wherein the second antenna comprises a pair of antennas configured to cooperatively transmit and receive information.

8. A method comprising:
determining, by a processing resource, a first orientation of a portable information handling system, the portable information handling system comprising a housing having a plurality of edges;
based on the first orientation, designating a first antenna as a primary antenna and designate a second antenna as a secondary antenna, the first antenna located proximate a first edge of the plurality of edges, the second antenna located proximate a second edge of the plurality of edges; and
directing, by the processing resource, a switch to transition the primary antenna to an active state and directing the switch to transition the secondary antenna to an inactive state, the switch communicatively coupled to the first antenna and the second antenna.

9. The method of claim 8, wherein determining the first orientation of the portable information handling system includes receiving a signal from an accelerometer communicatively coupled to the switch and the processing resource.

10. The method of claim 8, wherein the first antenna and the second antenna are separated by at least a predefined distance.

11. The method of claim 8, further comprising:
determining a second orientation of the portable information handling system; and
based on the second orientation, designating the second antenna as the primary antenna and designating the first antenna as the secondary antenna.

12. The method of claim 11, wherein the first orientation is a portrait orientation and the second orientation is a landscape orientation.

13. The method of claim 8, wherein the first antenna comprises a pair of antennas configured to cooperatively transmit and receive information.

14. The method of claim 8, wherein the second antenna comprises a pair of antennas configured to cooperatively transmit and receive information.

15. A non-transitory computer-readable medium storing instructions, that, when executed by a processor, cause the processor to:
determine a first orientation of a portable information handling system, the portable information handling system comprising a housing having a plurality of edges;
based on the first orientation, designate a first antenna as a primary antenna and designate a second antenna as a secondary antenna, the first antenna located proximate a first edge of the plurality of edges, the second antenna located proximate a second edge of the plurality of edges; and
direct a switch to transition the primary antenna to an active state and direct the switch to transition the secondary antenna to an inactive state, the switch communicatively coupled to the first antenna and the second antenna.

16. The medium of claim 15, wherein determining the first orientation of the portable information handling system includes receiving a signal from an accelerometer communicatively coupled to the switch and the processing resource.

17. The medium of claim 15, wherein the first antenna and the second antenna are separated by at least a predefined distance.

18. The medium of claim 15, wherein the processor is further caused to:
determine a second orientation of the portable information handling system; and
based on the second orientation, designate the second antenna as the primary antenna and designate the first antenna as the secondary antenna.

19. The medium of claim 18, wherein the first orientation is a portrait orientation and the second orientation is a landscape orientation.

20. The medium of claim 15, wherein the first antenna comprises a pair of antennas configured to cooperatively transmit and receive information.
